(19) United States
(12) Patent Application Publication
(10) Pub. No.: US 2017/0221073 A1
(43) Pub. Date: Aug. 3, 2017

(54) PROVIDING TECHNICAL SUPPORT TO A USER VIA A WEARABLE COMPUTING DEVICE

(71) Applicant: Hewlett-Packard Development Company, L.P., Houston, TX (US)

(72) Inventors: Garry S. Orsolini, Fair Oaks, CA (US); Bartolome Fernandez Carrasco, Sant Cugat (ES); John Mcmahon, Boise, ID (US)

(21) Appl. No.: 15/515,255

(22) PCT Filed: Sep. 29, 2014
(86) PCT No.: PCT/US2014/057999

§ 371 Date: Mar. 29, 2017

(51) Int. Cl. G06Q 30/00; H04N 7/15; H04W 4/02

(52) U.S. Cl. CPC G06Q 30/016; H04W 4/02; H04N 7/157

(57) ABSTRACT

Examples include providing technical support to a user via a wearable computing device, including identifying a user of the wearable computing device making a request to determine a user profile of the user, determining a location of the wearable computing device, determining, based on the user profile and the location of the wearable computing device, a virtual waiting room to place a digital representation of the user in, and transferring, based on a match between the user profile and at least one service personnel profile associated with the technical support center, the digital representation of the user from the virtual waiting room into a virtual private room.

### BACKGROUND

A technical support center provides a service to assist users of products such as electronic products or mechanical products or processes. Service personnel of the technical support center attempt to aid the user in resolving specific issues with the product or the process. Further, the service of the technical support center may be delivered to the user via telephone, electronic mail (email), websites, chats, onsite visits by the service personnel, or other mechanisms.

### BRIEF DESCRIPTION OF THE DRAWINGS

The accompanying drawings illustrate various examples of the principles described herein and are a part of the specification. The examples do not limit the scope of the claims.

FIG. 1 is a diagram of an example of a system for providing technical support to a user via a wearable computing device, according to one example of principles described herein.

FIG. 2 is a diagram of an example of a system for providing technical support to a user via a wearable computing device, according to one example of principles described herein.

FIG. 3 is a flowchart of an example of a method for providing technical support to a user via a wearable computing device, according to one example of principles described herein.

FIG. 4 is a flowchart of an example of a method for providing technical support to a user via a wearable computing device, according to one example of principles described herein.

FIG. 5 is a diagram of an example of a system for providing technical support to a user via a wearable computing device, according to one example of principles described herein.

FIG. 6 is a diagram of an example of a system for providing technical support to a user via a wearable computing device, according to one example of principles described herein.

FIG. 7 is a diagram of an example of a matrix for comparing user attributes with service personnel attributes for a number of service personnel, according to one example of principles described herein.

Throughout the drawings, identical reference numbers designate similar, but not necessarily identical, elements.

### DETAILED DESCRIPTION

As mentioned above, a technical support center provides a service to assist users of products such as electronic products or mechanical products or other users, such as assist medical personnel, during a process such as a medical procedure. Service personnel of the technical support center attempt to aid the user in resolving specific issues with the product or the process. Further, the service of the technical support center may be delivered to the user via telephone, electronic mail (email), websites, chats, onsite visits by the service personnel, or other mechanisms.

Many products and/or process are technically complex and need highly trained personnel to operate, support, and repair the product when the product and/or process does not perform as expected or fails. Typically, products reside at remote locations and the significant size of the product limits the products portability. Sending service personnel from the technical support center to instruct a user or repair an issue can be costly in terms of time, money, and opportunity cost. Further, in some countries where the product is installed, there are no resources available in that remote location to provide rapid response service. Still further, due to a product's and/or process's high complexity, in some occasions the user may need to reach an expert regarding a specific subject who may be in another remote location different from the user and the technical support center.

Additionally, a technical support center providing a service via telephone, emails, chat, and support forums have limited effectiveness, since the language used in the service does not always utilize common acronyms or naming conventions and the service personnel cannot be physically see the product.

Examples described herein include a method and system for providing technical support to a user via a wearable computing device. Such a method includes receiving a request from a wearable computing device, the request representing information related to an issue with a product or a process, identifying a user of the wearable computing device making the request to determine a user profile of the user, determining a location of the wearable computing device, determining, based on the user profile and the location of the wearable computing device, a virtual waiting room to place a digital representation of the user in, and transferring, based on a match between the user profile and at least one service personnel profile associated with the technical support center, the digital representation of the user from the virtual waiting room into a virtual private room. Such a method allows the user and the service personnel to communicate seamlessly via video and audio mechanisms provided by the wearable computing device in the virtual private room. As a result, the user is able to communicate with the service personnel seamlessly via video and audio mechanisms provided by the wearable computing device while being mobile enough to move significant distances.

In the present specification and in the appended claims, the term “wearable computing device” is meant to be understood broadly as a device that can be worn by a user for hands free use and is not limited to a specific area of operation. In one example, the wearable computing device includes features such as biometric inputs, a touch pad, a microphone, a camera, an audio speaker, a display, and other features, or combinations thereof. In an example, other features may include features to measure an environment which the wearable computing device is operating in. For example, a thermostat may be used to measure the temperature of an environment which the wearable computing device is operating in. A hygrometer may be used to measure the moisture content of an environment which the wearable computing device is operating in.

In the present specification and in the appended claims, the term “request” is meant to be understood broadly as information representing an issue with a product or a process. For example, a request may be an indication of an action initiated by a user to inform service personal of a technical support center of an issue with a product or a process. In one example, a request may be initiated via one or more actions on the wearable computing device. Actions may include touching a touch pad on the wearable computing device, giving a verbal command on the wearable computing device, gesture recognition, capturing an image via a camera on the wearable computing device, other actions, or combinations thereof. In another example, the wearable computing device may sense a threshold or control limit was triggered by, for example, a proximity to a machine or via biometrics of an individual, and automatically places the user's request into a virtual waiting room. Further, severity of the detected issue may be represented to a system for setting urgency of a response to the request.

In the present specification and in the appended claims, the term “virtual waiting room” is meant to be understood broadly as a virtual location for a digital representation of a user and provides content and/or functions for the user to interact with. In an example, a digital representation of a user is placed in the virtual waiting room until service personnel of the technical support center may assist the user in a virtual private room. In an example, the technical support center may include thousands of virtual waiting rooms. The virtual waiting rooms may be tailored to specific user attributes and/or service personnel attributes such as specific service personnel, a country, a language, a skill level, other attributes, or combinations thereof.

In the present specification and in the appended claims, the term “virtual private room” is meant to be understood broadly as a virtual location where a digital representation of a user and a digital representation of service personnel commence collaborative services. In an example, collaborative service may include voice collaborations, video collaborations, content sharing, such as drawings, pictures, image, other collaborative services, or combinations thereof between the user and the service personnel. In an example, the virtual private room provides and/or hosts such collaborative services via desktop sharing, whiteboard, chat, audio, video, file sharing, among others.

In the present specification and in the appended claims, the term “digital representation of a user” is meant to be understood broadly as a mechanism to define a user in a virtual waiting room and/or a virtual private room. Since the user cannot physically be located in a virtual waiting room and/or a virtual private room, a digital representation of the user may be placed in a virtual waiting room and/or a virtual private room. In an example, the digital representation of the user may include a specific name for a user that is distinct from all other users in a virtual waiting room and/or a virtual private room. In an example, the specific name for a user may be stored in a database and associated with a user profile. Further, the digital representation of the user may include other user attributes, such as a language, a country, a skill level, an installed based, other specific user attributes that are distinct from all other users in a virtual waiting room and/or a virtual private room. The user attributes may be stored in a database and associated with a user profile.

In the present specification and in the appended claims, the term “digital representation of service personnel” is meant to be understood broadly as a mechanism to define service personnel in a virtual waiting room and/or a virtual private room. Since the service personnel cannot physically be located in a virtual waiting room and/or a virtual private room, a digital representation of the service personnel may be placed in a virtual waiting room and/or a virtual private room. In an example, the digital representation of the service personnel may include a specific name for service personnel that is distinct from all other service personnel in a virtual waiting room and/or a virtual private room. In an example, the specific name for service personnel may be stored in a database and associated with a service personnel profile. Further, the digital representation of the service personnel may include other service personnel attributes, such as a language, a country, a skill level, an installed based, other specific service personnel attributes that are distinct from all other service personnel in a virtual waiting room and/or a virtual private room. The attributes may be stored in a database and associated with a service personnel profile.

In the present specification and in the appended claims, the term “printing device” is meant to be understood broadly as a peripheral device that makes persistent human-readable representations of graphs and/or text on a printing medium such as paper. In an example, the printing device may be a small portable printing device that may be easily moved from one location to another location. In another example, the printing device may be a large non-portable printing device that may not be easily moved from one location to another location.

In the present specification and in the appended claims, the term “match” is meant to be understood broadly as a determination that a user profile and a service personnel profile have corresponding user attributes and service personnel attributes. In an example, a match is determined based on a highest level of corresponding user attributes and service personnel attributes.

In the following description, for purposes of explanation, numerous specific details are set forth in order to provide a thorough understanding of the present systems and methods. It will be apparent, however, to one skilled in the art that the present apparatus, systems, and methods may be practiced without these specific details. Reference in the specification to “an example” or similar language means that a particular feature, structure, or characteristic described in connection with that example is included as described, but may not be included in other examples.

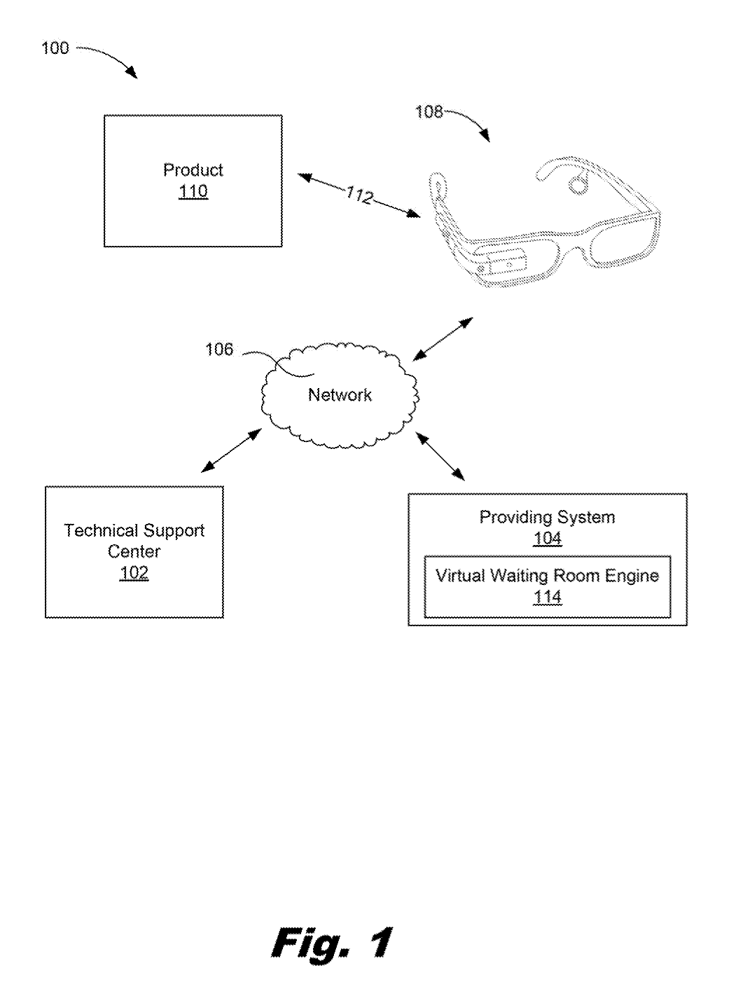

Referring now to the figures, FIG. 1 is a diagram of an example of a system for providing technical support to a user via a wearable computing device, according to one example of principles described herein. As will be described below, a providing system is in communication with a network to receive a request from a wearable computing device, the request representing information related to an issue with a product or a process. Further, the providing system identifies a user of the wearable computing device making the request to determine a user profile of the user. The providing system further determines a location of the wearable computing device. Further, the providing system determines, based on the user profile and the location of the wearable computing device, a virtual waiting room to place a digital representation of the user in. The providing system further transfers, based on a match between the user profile and at least one service personnel profile associated with the technical support center, the digital representation of the user from the virtual waiting room into a virtual private room specific to the service personnel.

In one example, the system (100) includes a product (110). In an example, the product (110) may be an electronic product such as a printing device (e.g., printer), a computer device, a server, or other electronic product. In another example, the product (110) may be a mechanical product such as exercise equipment, furniture, a manufacturing machine, other mechanical products, or combinations thereof. In an example, the product (110) may be large in size and service personal of a technical support center (102) may have to physically inspect the product (110) to aid the user in resolving an issue with the product (110).

As illustrated in FIG. 1, the system (100) includes a technical support center (102). The technical support center (102) may include one or more service personnel trained to assist a user in resolving issues with the product (110). In an example, the technical support center (102) may include a collection of service personnel residing at the same physical location. In another example, the technical support center (102) may include a collection of service personnel residing at different physical location. Further, the service personnel may be represented as digital representations of service personnel in virtual waiting rooms and virtual private rooms associated with the technical support center (102). As will be described in other parts of this specification, the technical support center (102) includes a virtual waiting room and a multitude of virtual private rooms. In one example, the technical support center (102) may be implemented by one or more computing devices that allow the service personnel to access the virtual private rooms. In an example, the virtual waiting rooms and the virtual private rooms are electronically created by the service personnel in any suitable manner. Further, the virtual waiting rooms and the virtual private rooms may include specific room names and includes a specific set of keys that allows a digital representation of a user and digital representations of service personnel to enter the virtual waiting rooms and the virtual private rooms. More information about the technical support center (102) will be described in other parts of this specification.

In one example, the system (100) includes a wearable computing device (108). In an example, the wearable computing device (108) may be a device that can be worn by a user for hands free use and is not limited to a specific area of operation. As illustrated, the wearable computing device (108) may take the form of glasses that the user wears. As will be described in other parts of this specification, the wearable computing device (108) includes one or more features, such as biometrics capture mechanism, a microphone, a display, a camera, audio speakers, other features, or combinations thereof, to allow the user to send a request to the technical support center (102) overtly or by a threshold trigger that automatically sends the request to the technical support center (102). Further, the features of the wearable computing device (108) enable the sharing of content related to the request between service personnel of the technical support center (102) and the user via the wearable computing device (108). More information about the wearable computing device (108) will be described in other parts of this specification.

The system (100) further includes a providing system (104). In an example, the functionalities of the providing system (104) are implemented by hardware or a combination of hardware and executable instructions (e.g., processor(s) and executable instructions stored on machine-readable storage media). As will be described in other parts of this specification, the providing system (104) receives a request from a wearable computing device (108), the request representing information related to an issue with the product (110) or a process. In an example, the request may be provided to the providing system (104) in response to actions such as verbal commands, an image capture of the product (110), a user tapping a touch pad, other actions, or combinations thereof. In one example, these actions may be performed on the wearable computing device (108).

The providing system (104) further identifies a user of the wearable computing device (108) making the request to determine a user profile of the user. As will be described in other parts of this specification, the user may be identified via biometrics, a quick response (QR) code, a password, a user name, a company that has registered the wearable computing device (110) with the technical support center (102), proximity (112) of the wearable computing device (108) to the product (110), or combinations thereof.

Further, the providing system (104) determines a location of the wearable computing device (108). As will be described in other parts of this specification, the location of the wearable computing device (108) may be determined by a global positioning system (GPS), proximity (112) of the product (110) to the wearable computing device (108), a history associated with the user profile, or combinations thereof.

The providing system (104) determines, based on the user profile and the location of the wearable computing device (108), a virtual waiting room to place a digital representation of the user in. In an example, the technical support center (102) may include one or more virtual waiting rooms. The virtual waiting rooms may be tailored to specific user attributes and/or service personnel attributes such as a country, a language, a skill level, preferred personnel, other attributes, or combinations thereof. As will be described below, a virtual waiting room engine (114) may be utilized to determine a virtual waiting room to place the digital representation of the user in.

Further, the providing system (104) transfers, based on a match between the user profile and at least one service personnel profile associated with the technical support center, the digital representation of the user from the virtual waiting room into a virtual private room. As a result, the user is able to communicate, via the wearable computing device (108), with the service personnel seamlessly while being mobile enough to move significant distances. In an example, the user is able to communicate with the service personnel over a network (106). More information about the providing system (104) will be described later on in this specification.

While this example has been described with reference to the providing system being located over the network, the providing system may be located in any appropriate location according to the principles described herein. For example, the providing system may be located in a wearable computing device, a server, a datacenter, the technical support center, other locations, or combinations thereof.

While this example has been described with reference to the wearable computing device being glasses, the wearable computing device may be in any wearable form. For example, the wearable computing device may be a watch, a hat, a stylish but functional necklace and/or collar, other forms, or combinations thereof with the features described above.

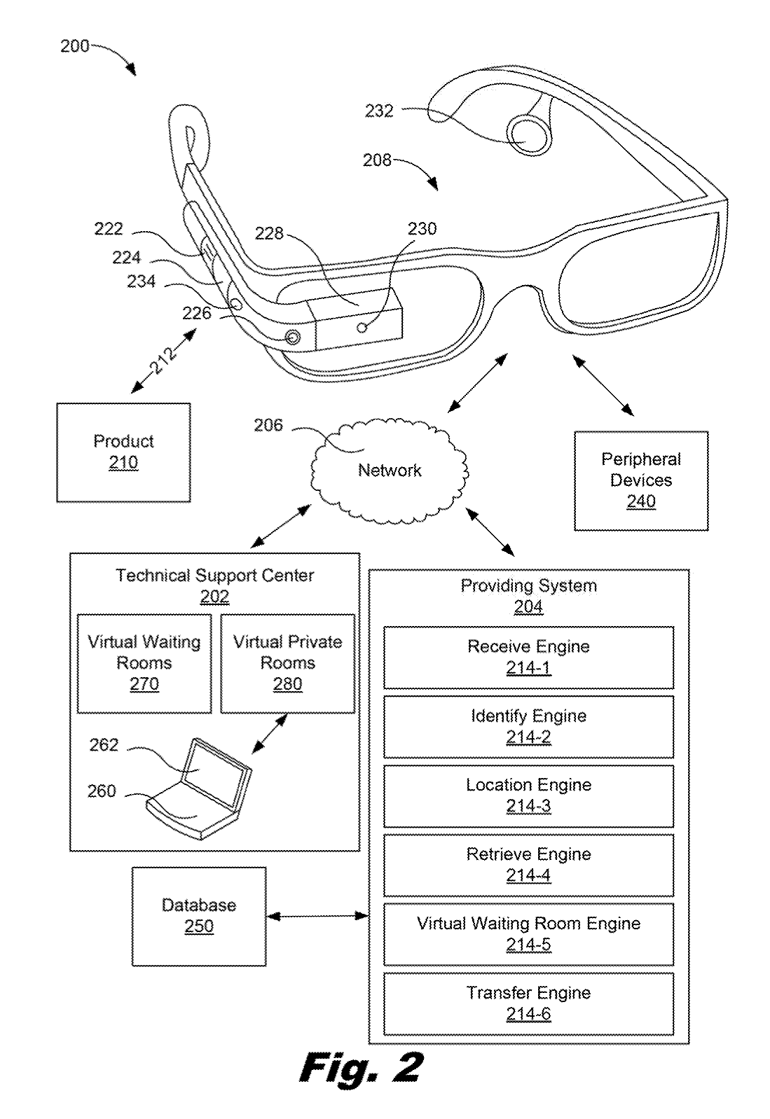

FIG. 2 is a diagram of an example of a system for providing technical support to a user via a wearable computing device, according to one example of principles described herein. As described above, a providing system is in communication with a network to receive a request from a wearable computing device, the request representing information related to an issue with a product or a process. Further, the providing system identifies a user of the wearable computing device making the request to determine a user profile of the user. The providing system further determines a location of the wearable computing device. Further, the providing system determines, based on the user profile and the location of the wearable computing device, a virtual waiting room to place a digital representation of the user in. The providing system further transfers, based on a match between the user profile and at least one service personnel profile associated with the technical support center, the digital representation of the user from the virtual waiting room into a virtual private room.

As illustrated in FIG. 2, the system includes a wearable computing device (208). In an example, the wearable computing device (208) may be a device that can be worn by a user for hands free use and is not limited to a specific area of operation. As illustrated, the wearable computing device (208) may be a computing device in the form of glasses that the user wears.

As mentioned above, the wearable computing device (208) includes one or more features (222, 224, 226, 228, 230, 232, 234). In an example, the wearable computing device (208) includes biometric inputs (222, 230). In an example, this may include a fingerprint recognition mechanism (222).

Once the user's fingerprint is captured, a matching algorithm may be used to compare previously stored templates of fingerprints, in the database (250), against the user's fingerprints for authentication purposes. As will be described below, the fingerprint recognition mechanism (222) may aid the providing system in identifying a user of the wearable computing device (208) making a request to determine a user profile of the user.

As mentioned above, the wearable computing device (208) includes one or more features (222, 224, 226, 228, 230, 232, 234). In an example, the wearable computing device (208) includes a retinal scanner (230). The retinal scanner (230) may scan an eye of the user to identify patterns of the user's retina.

As mentioned above, the wearable computing device (208) includes one or more features (222, 224, 226, 228, 230, 232, 234). In an example, the wearable computing device (208) includes a touch pad (224). The touch pad (224) allows the wearable computing device (208) to distinguish when the user is interacting with the wearable computing device (208). In an example, the user may touch the touch pad (224), say a verbal command, and the voice recognition of the wearable computing device (208) interprets the verbal command and executes the verbal command. For example, a user may touch the touch pad (224) and give a verbal command such as take an image. The voice recognition of the wearable computing device (208) receives the verbal command via a microphone (234), interprets the verbal command, and takes an image via a camera (226). In another example, the user may touch the touch pad (224) and give a verbal command such as call the technical support center (202) with regard to a product (210). The voice recognition of the wearable computing device (208) receives the verbal command via a microphone (234), interprets the verbal command, and calls the technical support center (202) with regard to the product (210).

In another example, the wearable computing device (208) may include gesture recognition. For example, a user may perform a gesture, the gesture recognition allows the wearable computing device (208) to interpret the gesture, and perform an action based on the gesture. For example, a user may perform a gesture such as waving their hands back and forth three times. The gesture recognition allows the wearable computing device (208) to interpret the gesture. In this example, the gesture signifies the user is having an issue with a product and to call a technical support center regarding the product. As a result, the wearable computing device (208) calls a technical support center.

As mentioned above, the wearable computing device (208) includes one or more features (222, 224, 226, 228, 230, 232, 234). In an example, the wearable computing device (208) includes a display (228). As will be described below, the display (228) enables sharing of content, such as visual content, related to the request between service personnel of the technical support center (202) and the user via the wearable computing device (208).

As mentioned above, the wearable computing device (208) includes one or more features (222, 224, 226, 228, 230, 232, 234). In an example, the wearable computing device (208) includes an audio speaker (232). As will be describe below, the audio speaker (232) enables sharing of content, such as audio content, related to the request between service personnel of the technical support center and the user via the wearable computing device (208).

As mentioned above, the wearable computing device (208) includes one or more features (222, 224, 226, 228, 230, 232, 234). In an example, the wearable computing device (208) includes a camera (226). In one example, the camera (226) may be a two-dimensional camera. In another example, the camera (226) may be a three-dimensional camera. As will be described below, the camera (226) enables sharing of content, such as video content, related to the request between service personnel of the technical support center and the user via the wearable computing device.

In an example, the camera (226) may be used to capture video and obtain a snapshot every time a frame of content changes with significance. In an example, the snapshots may be compared, for example, in a background or parallel process, to content on file or via enhanced context analytics. This process aids to isolate context and also automatically match solutions to issues indicated in the request.

In an example, the wearable computing device (208) includes other features. For example, the wearable computing device (208) may include a feature to sense temperature or a change in temperature. This feature may be used to take or cause an action. The wearable computing device (208) may include a feature to sense motion in any direction, a change of a direction, a change in acceleration, or a change in deceleration. This feature may be used to take or cause an action. More information about the other features is described in other parts of this specification.

As illustrated in FIG. 2, the system (200) includes a providing system (204). The providing system (204) includes a receive engine (214-1), an identify engine (214-2), a location engine (214-3), a retrieve engine (214-4), a virtual waiting room engine (214-5), and a transfer engine (214-6). The engines (214) may be implemented as hardware or a combination of hardware and program instructions to perform a designated function. The engines 214-1-214-6 may be any combination of hardware and programming to implement the functionalities of the engines described herein. In examples described herein, such combinations of hardware and programming may be implemented in a number of different ways. For example, the programming for the engines may be processor executable instructions stored on at least one non-transitory machine-readable storage medium and the hardware for the engines may include at least one processing resource to execute those instructions. In other examples, the functionalities of any of engines 214-1-214-6 may be implemented in the form of electronic circuitry.

As mentioned above, the providing system (204) includes a receive engine (214-1). The receive engine (214-1) receives a request from a wearable computing device (208), the request representing information related to an issue with a product (210) or a process. In an example, the request may be made via a verbal command. For example, the user may touch the touch pad (224), say a verbal command, and the voice recognition of the wearable computing device (208) interprets the verbal command and executes the verbal command. The voice recognition of the wearable computing device (208) receives the verbal command via a microphone (234), interprets the verbal command, and places the digital representation of the user in the proper virtual waiting room of the technical support center (202) with regard to the product (210).

As mentioned above, the providing system (204) includes the identify engine (214-2). The identify engine (214-2) identifies a user of the wearable computing device (208) making the request to determine a user profile of the user.

In one example, identify engine (214-2) identifies the user via biometrics. As mentioned above, the wearable computing device (208) includes biometric inputs (222, 230). In an example, this includes the fingerprint recognition mechanism (222). As mentioned above, the fingerprint recognition mechanism (222) is used to capture a fingerprint of the user. Once the user's fingerprint is captured, a matching algorithm may be used to compare previously stored templates of fingerprints, in the database (250), against the user's fingerprints for authentication purposes. As a result, the fingerprint recognition mechanism (222) may aid the identify engine (214-2) in identifying a user of the wearable computing device (208) making a request to determine a user profile of the user. In other examples, a retinal scanner (230) or other biometric input device may be used in a similar manner.

In another example, the identify engine (214-2) may identify the user via a bar code (e.g., a QUICK RESPONSE (QR) code), or other machine-readable image that contains information about the user. In one example, a user may be assigned a specific QR code. In this example, the QR code may be attached to a user's badge. In an example, the camera (226) on the wearable computing device (208) may be used to capture an image of the QR code. Once the user's QR code is captured, a matching algorithm may be used to compare previously stored QR codes, in the database (250), against user's OR code for authentication purposes. As a result, the QR code may aid the identify engine (214-2) in identifying a user of the wearable computing device (208) making a request to determine a user profile of the user.

In another example, the identify engine (214-2) may identify the user via at least one of a username and a password, which may be received via a microphone (234).

In another example, the identify engine (214-2) may identify the user via a company that has registered with the wearable computing device (208) with the technical support center (202). For example, a company may have a registered with the wearable computing device (208) with the technical support center (202). In this example, a specific company name may be assigned to each wearable computing device (208). For example, a company's name may be company X. Further, the company's name may be stored in the database (250). In this example, when a user sends a request, the providing system (204) may ask for the company's name. The user may touch the touch pad (224) and give the company name such as company X. The voice recognition of the wearable computing device (208) receives the user name via a microphone (234) and interprets the company name as company X. Once the company name is captured, a matching algorithm may be used to compare previously stored company names, in the database (250), against company's name for authentication purposes. As a result, the company name may aid the identify engine (214-2) in identifying a user of the wearable computing device (208) making a request to determine a user profile of the user.

In yet another example, the identify engine (214-2) may identify the user via proximity of the wearable computing device (208) to the product (210). For example, the wearable computing device (208) and the product (210) may include one or more sensors that allows the providing system (204) to determine proximity of the wearable computing device (208) to the product (210). In an example, the sensors may be wireless. In an example, a company may have two products, product A and product B. Further, a company may have one wearable computing device. In this example, the wearable computing device and the product may include one or more sensors. The sensors determine a distance from the products to the wearable computing device. For example, if the wearable computing device is two meters form product A, the sensors determine that the user is two meters from product A. Further, a company may have two employees, user A and user B. In an example, user A may be assigned to product A. User B may be assigned to product B. This information may be stored in the database (250) as a user profile. In this example, when a user sends a request, the providing system (204) determines proximity of the wearable computing device to the products. In this example, the providing system (204) determines the proximity of the wearable computing device is one meter from product A and twenty meters from product B. Once the proximity is captured, a matching algorithm may be used to compare proximity information in the database (250), against a user's proximity to a product for authentication purposes. In this example, since user A is assigned to product A, the identify engine (214-2) identifies the user as user A. As a result, proximity may aid the identify engine (214-2) in identifying a user of the wearable computing device (208) making a request to determine a user profile of the user.

As mentioned above, the providing system (204) includes a location engine (214-3). The location engine (214-3) determines a location of the wearable computing device. In an example, the location engine (214-3) utilizes a global positioning system (GPS) to determine the location of the wearable computing device. For example, the wearable computing device (208) may include a GPS computer circuit to allow the location engine (214-3) to capture an exact location of the wearable computing device (208). Once the exact location is captured, a matching algorithm may be used to compare the exact location with the location of a product (210) stored in the database (250), against the user's exact location to determine a location of the wearable computing device. As a result, GPS may aid the location engine (214-3) to determine a location of the wearable computing device.

In another example, the location engine (214-3) determines proximity of the product (210) to the wearable computing device (208) to determine the location of the wearable computing device. As mentioned above, the wearable computing device (208) and the product (210) may include one or more sensors. The sensors may be used to determine a distance from the product (210) to the wearable computing device (208). As a result, a proximity may be determined by the location engine (214-3) via the sensors.

In another example, the location engine (214-3) determines a history associated with the user profile to determine the location of the wearable computing device. In one example, once the user is identified via the identify engine (214-2), the location engine (214-3) may access the user profile, stored in the database (250) to determine the location of the wearable computing device. For example, the user profile may include information that indicates the user works for company X which is located at address Y. In this example, the location engine (214-3) determines the wearable computing device is at location Y.

As mentioned above, the providing system (204) includes a retrieve engine (214-4). The retrieve engine (214-4) retrieves, based on the user profile, a history of the user. As will be described below, the history may aid the providing system (204) in determining a location of the wearable, computing device, determining a virtual waiting room to place the user in, or combinations thereof. In an example, the history may include product records, texts, chats, documents, recordings, references, among others. Further, the history may be used to prepopulate a private waiting room so that continuity of technical support may be seamless and a premium user experience is provided.

As mentioned above, the providing system (204) includes a virtual waiting room engine (214-5). The virtual waiting room engine (214-5) determines, based on the user profile and the location of the wearable computing device, a virtual waiting room to place the a digital representation of the user in. In an example, a virtual waiting room is a virtual location for a digital representation of a user and provides content and/or functions for the user to interact with. In an example, a digital representation of a user is placed in the virtual waiting room until a digital representation of service personnel of the technical support center may assist the digital representation of the user in a virtual private room. In an example, the technical support center may include thousands of virtual waiting rooms. In an example, the virtual waiting rooms are electronically created by the service personnel in any suitable manner. As a result, the virtual waiting rooms may be tailored to specific user attributes and/or service personnel attributes such as specific service personnel, a country, a language, a skill level, other attributes, or combinations thereof. As illustrated, the technical support center (202) includes one or more virtual waiting rooms (270). In an example, the virtual waiting rooms (270) may be based on user attributes and/or service personnel attributes. For example, the user attributes and/or service personnel attributes may include a country. For example, the technical support center (202) may include a virtual waiting room for users residing the United States. In another example, the technical support center (202) may include a virtual waiting room for users residing in the United Kingdom. In another example, the technical support center (202) may include a virtual waiting room for users residing in South America.

In another example, the user attributes and/or service personnel attributes may include a language. For example, the technical support center (202) may include a virtual waiting room for users that speak English. In another example, the technical support center (202) may include a virtual waiting room for users that speak Spanish.

In another example, the user attributes and/or service personnel attributes may include a skill level. For example, the technical support center (202) may include a virtual waiting room based on a skill level of the user and/or the service personnel. For example, if the user's skill level is novice, the technical support center (202) may include a virtual waiting room for novices. As a result, service personnel having at least a novice skill level may assist the user. If the user's skill level is advanced, the technical support center (202) may include a virtual waiting room for advanced users. As a result, service personnel having at least an advanced skill level may assist the user. If the user's skill level is expert, the technical support center (202) may include a virtual waiting room for experts. As a result, service personnel having an expert skill level may assist the user.

In another example, the user attributes and/or service personnel attributes may include a preferred service personnel represented by a username of a service personnel. For example, if a user prefers to have service personnel A from the technical support center (202), the technical support center (202) may include a virtual waiting room for service personnel A.

In another example, the user attributes and/or service personnel attributes may include an installed base model number. In an example, an installed base model number may be a combination of unit model number and serial number associated with the product (210). Further, the technical support center (202) may include virtual waiting rooms (270) for one or more installed base model numbers.

In another example, the service personnel attributes may include if a service personnel is available to transfer the digital representation of the user from a virtual waiting room to a virtual private room. As will be described below, the user attributes and/or service personnel attributes may be represented as a matrix to determine when the transfer engine (214-6) transfers the digital representation of the user from a virtual waiting room to a virtual private room.

In an example, the technical support center (202) may include thousands of virtual waiting rooms to specifically accommodate the user attributes and/or service personnel attributes or combinations of the user attributes and/or service personnel attributes. As a result, a premium user experience may be provided.

In an example, the virtual waiting rooms (270) allows a user to present at least one question regarding the request and receive at least one solution to the at least one question regarding the request. In an example, the user may present a question. For example, while in the virtual waiting room, the user may touch the touch pad (224) and as a question such as how to turn the product (210) on. The voice recognition of the wearable computing device (208) receives the question via a microphone (234) and interprets the question via the virtual waiting room engine (214-5). In an example, the database (250) may include one or more recorded solutions to questions about the product (210). The virtual waiting room engine (214-5) may search the database for recorded solutions on how to turn the product (210) on. If the virtual waiting room engine (214-5), finds a recorded solution, the virtual waiting room engine (214-5) plays the recorded solution back via the wearable computing device (208). In an example, the recorded solution is played back via the display (228) and/or the speaker (232) of the wearable computing device (208). In another example, the recorded solution may be sent to peripheral devices (240), such as a printer, if desired. In this example, if the recorded solution aided the user in resolving the issue, the user may leave the virtual waiting rooms (270) without entering in the virtual private rooms (280).

In another example, if a recorded solution is not found in the database (250), the virtual waiting room engine (214-5) may access the World Wide Web, the internet, or the intranet for a solution. In an example, the virtual waiting room engine (214-5) may access the World Wide Web, the internet, or the intranet via the network (206). Further, the virtual waiting room engine (214-5) may use analytics to search for video, audio, images, and text that may aid the user in resolving the issue with the product (210). In an example, the analytics may be image recognition, video recognition, text recognition, other types of recognition, or combinations thereof. In an example, if the solution is found, the solution is played back via the display (228) and/or the speaker (232) of the wearable computing device (208). In another example, the solution may be sent to peripheral devices (240), such as a printing device, if desired. In this example, if the solution aided the user in resolving the issue, the digital representation of the user may leave the virtual waiting room (270) without entering in the virtual private room (280).

As mentioned above, the providing system (204) includes a transfer engine (214-6). In an example, the transfer engine (214-6) transfers, based on a match between the user profile and at least one service personnel profile associated with the technical support center (280), the digital representation of the user from the virtual waiting room (270) into a virtual private room (280).

In an example, once the digital representation of the user enters one of the virtual waiting rooms (270) the transfer engine (214-6) receives user attributes associated with the user profile. In one example, the user attributes may be stored in the database (250). The user attributes may be geographic and demographic in nature. Further, the user attributes may be associated with specific products and specific preferences. In an example, the user attributes may include preferred service personnel, a country, a language, a skill level, an installed base model for a product, other user attributes, or combinations thereof. In one example, for some business models, the preferred service personnel attribute may be managed exclusively by service personnel.

In an example, once the digital representation of the user enters one of the virtual waiting rooms (207) the transfer engine (214-6) receives service personnel attributes associated with service personnel profiles for all digital representations of service personnel in the virtual waiting rooms (270). In an example, each of the digital representations of service personnel may have a specific service personnel profile. Further, each of the specific service personnel profiles may include service personnel attributes. In an example, the service personnel attributes may be stored in the database (250). Further, the service personnel attributes may be associated with specific products. In an example, the service personnel attributes may include, a country, a language, a skill level, an installed base model for a product, other user attributes, or combinations thereof.

Further, the transfer engine (214-6) compares the user attributes with the service personnel attributes to determine if the match is detected. In an example, the transfer engine (214-6) may use a matrix to compare the user attributes with the service personnel attributes. For example, the transfer engine (214-6) may compare specific user attributes with specific service personnel attributes for all digital representations of service personnel in the virtual waiting rooms (270) via a matrix. In an example, the matrix may include one column for each user attribute. Further, the matrix may include one or more rows. In an example, each row corresponds to a service personnel profile. If a specific user attributes matches specific service personnel attribute in the matrix, an entry for the corresponding matrix receives a 1, otherwise the entry for the corresponding matrix may receive a 0. The more 1's on the row of a matrix, the more a service personnel profile matches a user profile.

In an example, for a match to be detected, user attributes such as country, language, skill level, and installed base model for a product are to match service personnel attributes for country, language, skill level, and installed base model for a product. For example, if the user attributes indicate that the user lives in German, speaks German, has a novice skill level, and has an issue with installed base model X of product Y, these user attributes are compared against all service personnel attributes for all digital representations of service personnel in the virtual waiting rooms (270). For example, three digital representations of service personnel may be in the virtual waiting rooms (270). In one example, service personnel one's service personnel attributes indicate that the service personnel one lives in Spain, speaks Spanish, has a novice skill level, and has can resolve issue with installed base model X of product Y. In this example, the transfer engine (214-6) determines service personnel one matches two attributes of the user attributes. As a result, the matrix receives two 1's for the row corresponding to service personnel one. Further, service personnel two's service personnel attributes indicate that the service personnel two lives in France, speaks German and French, has a novice skill level, and has can resolve issues with installed base model X of product Y. In this example, the transfer engine (214-6) determines service personnel two matches three attributes of the user attributes. As a result, the matrix receives three 1's for the row corresponding to service personnel two. Further, service personnel three's service personnel attributes indicate that the service personnel three lives in German, speaks German, has a novice skill level, and can resolve issues with installed base model X of product Y. In this example, the transfer engine (214-6) determines service personnel three matches four attributes of the user attributes. As a result, the matrix receives four 1's for the row corresponding to service personnel three.

Further, the transfer engine (214-6) assigns a priority to the match. In keeping with the given example, service personnel one matches two attributes of the user attributes, service personnel two matches three attributes of the user attributes, and service personnel three matches four attributes of the user attributes. In this example, each of the service personnel may be a match for user attributes to a degree. In an example, service personnel one is given a low priority since service personnel one matches two attributes of the user attributes. Service personnel two is given a medium priority since service personnel two matches three attributes of the user attributes. Service personnel three is given a high priority since service personnel three matches four attributes of the user attributes.

The transfer engine (214-6) further allows, based on the priority of the match, the digital representation of the user to be transferred from the virtual waiting room into the virtual private room. In an example, a matching algorithm, the transfer engine (214-6), or any suitable method may be used to transfer the digital representation of the user from the virtual waiting room into the virtual private room. In an example, since the user attributes best match service personnel attributes of service personnel three, the digital representation of the user to be transferred from the virtual waiting room (270) into the virtual private room (280) associated with service personnel three.

In one example, if no matching service personnel are available, the user may be notified. For example, the user may be notified via a message displayed in the display (228) of the wearable computing device (208). In this example, the message may state no service personnel are available at this time.

In one example, the virtual private room (280) enables sharing of content related to the request between service personnel of the technical support center and the user via the wearable computing device (208). As mentioned above, the wearable computing device (208) may send and receive content via some of the features (222, 224, 226, 228, 230, 232, 234).

While FIG. 2 is directed towards providing a user with technical support via the wearable computing device for a product, technical support may be used to allow the user to communicate with an expert and provide assistance for a process or procedure that is not associated with an electronic product or machine. For example, the wearable computing device could be used to evaluate damage and triage issues after a natural disaster and relay this information to an expert. In another example, the user may be a dentist performing a procedure and the wearable computing device may be used to receive assistance from an expert.

While this example has been described with reference to using sensor to determine a proximity, near filed communication (NFC) may be used to determine a proximity. For example, NFC allows the sharing of information between devices when the devices become close to each other. In an example, the wearable computing device may use NFC to communicate with the product. This allows the wearable computing device to gather all necessary information such as telemetry, serial number, and firmware version from a product. Further, the wearable computing device can share this information with a technical support center for quick diagnosis.

An overall example of the system (200) will now be explained. In an example, a user determines that a product (210) or a process has an issue that needs to be resolved by a technical support center (202). The user may touch the touch pad (224) and give a verbal command and places the user in the proper virtual waiting room of the technical support center with regard to the product (210). The voice recognition of the wearable computing device (208) receives the verbal command via a microphone (234), interprets the verbal command, and places the user in the proper virtual waiting room of the technical support center with regard to the product (210). The receive engine (214-1) receives the request from a wearable computing device (208).

In an example, the identify engine (214-2) identifies the user of the wearable computing device (208) making the request to determine a user profile of the user. In this example, the user is identified via the fingerprint recognition mechanism (222) as described above.

The location engine (214-3) determines the location of the wearable computing device (208). In this example, the location engine (214-3) determines the location of the wearable computing device (208) via GPS. In this example, the location engine (214-3) determines the wearable computing device (208) is in country X, in company X's building, and an exact location within company X's building.

The retrieve engine (214-4) retrieves, based on the user profile, a history of the user. In this example, the history of the user indicates the user is associated with the product (210). Further, the history indicates the user has not had previous issues with the product (210). In another example, the retrieve engine (214-4) can evaluate additional data from the wearable computing device (208) such as temperature, motion, or deltas from standardized norms to assist in evaluating the severity or urgency of an issue with the product (210).

Based on the user profile and the location of the wearable computing device, a digital representation of the user is placed in a virtual waiting room by the virtual waiting engine (214-5). The virtual waiting rooms (270) allows the user to present at least one question regarding the request and receive at least one solution to the at least one question regarding the request. In an example, the user may present a question such how to wirelessly link the product (210) with product Z. For example, while in the virtual waiting room, the user may touch the touch pad (224) and ask a question such as how to wirelessly link the product (210) with product Z. The voice recognition of the wearable computing device (208) receives the question via a microphone (234) and interprets the question via the virtual waiting room engine (214-5). In an example, the virtual waiting room engine (214-5) may search the database (250) and/or the World Wide Web, the internet, or the intranet with regard to the user's question. In this example, the virtual waiting room engine (214-5) is unable to retrieve a solution to the user's questions. As a result, the digital representation of the user remains in one of the virtual waiting rooms (270) until transferred to one of the virtual private rooms (280).

In one example, the transfer engine (214-6) transfers, based on the match between the user profile and the at least one personnel profile associated with the technical support center, the digital representation of the user from the virtual waiting room (270) into the virtual private room (280) as described above. Further, the transfer engine (214-6) enables sharing of content related to the request between personnel of the technical support center and the user via the wearable computing device (208) until the issue is resolved with the product (210) as described above. In an example, interaction between the user and the service personnel may include sensitive information. As a result, the providing system (204) may include industry standard data encryption. Once the issue is resolved with the product (210) the digital representation of the user leaves the virtual private room (280).

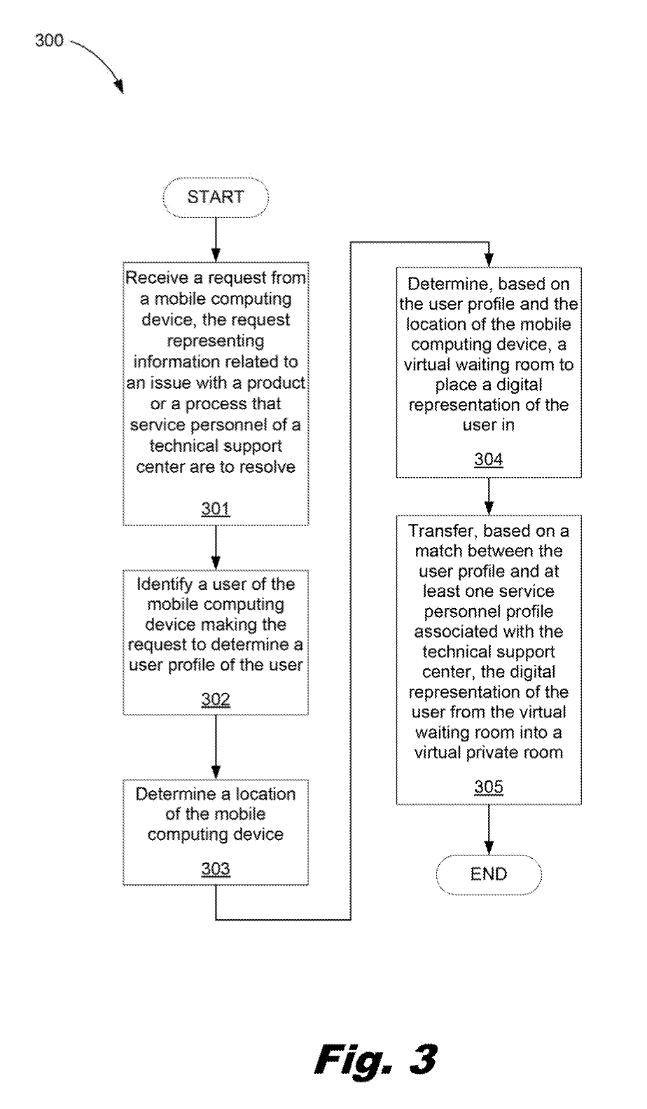

FIG. 3 is a flowchart of an example of a method for providing technical support to a user via a wearable computing device, according to one example of principles described herein. In one example, the method (300) may be executed by the system (100) of FIG. 1. In other examples, the method (300) may be executed by other systems such as system 200, system 500 or system 600. As a result, the functionalities of the method (300) are implemented by hardware or a combination of hardware and executable instructions. In this example, the method (300) includes receiving (301) a request from a wearable computing device, the request representing information related to an issue with a product or a process, identifying (302) a user of the wearable computing device making the request to determine a user profile of the user, determining (303) a location of the wearable computing device, determining (304), based on the user profile and the location of the wearable computing device, a virtual waiting room to place a digital representation of the user in, and transferring (305), based on a match between the user profile and at least one service personnel profile associated with the technical support center, the digital representation of the user from the virtual waiting room into a virtual private room.

As mentioned above, the method (300) includes receiving (301) a request from a wearable computing device, the request representing information related to an issue with a product or a process. As mentioned above, the request may be made via an indication of an action such as a verbal command, a photograph, a threshold trigger, other actions, or combinations thereof.

In an example, the request includes information to determine a priority of the request. For example, the wearable computing device may sense a threshold or control limit was triggered by, for example, a proximity to a machine, via biometrics on an individual or a temperature sensor. This additional information about the threshold may be included in the request. Further, the priority of the request may be based on the severity of the information in the request. For example, if the threshold is barely exceeded, this information may be used to determine the priority of the request is low. However, if the threshold has been severely exceeded, this information may be used to determine the priority of the request is high. As a result, the user may be assisted sooner rather than later by service personnel.

As mentioned above, the method (300) includes identifying (302) a user of the wearable computing device making the request to determine a user profile of the user. In one example, identifying the user of the wearable computing device making the request to determine the user profile of the user includes identifying the user via biometrics, a QR code, a password, a user name, a company that has registered with the wearable computing device with the technical support center, a proximity of the wearable computing device to the product, or combinations thereof. Further, other methods and techniques may be used to identifying a user of the wearable computing device making the request.

In an example, the user profile may include one or more user attributes associated with the user. In an example, the user attributes may include a country the user resides in, a language the use speaks, a skill level, a company the user works for, a location of the company, preferred service personal, a history of the user, other attributes or combinations thereof. As mentioned in FIG. 2, a database may store one or more user profiles. Further, the providing system of FIG. 2 may access the user profile to provide additional information needed by the method (300). In other examples, the user profile may be stored in other locations. For example, the user profile may be stored in the wearable computing device, a technical support center, a server, other locations, or combinations thereof.

As will be described below, the user profile may be used to aid the method (300) in determining a virtual waiting room to place the digital representation of the user in, when to transfer the digital representation of the user form the virtual waiting room into a virtual private room, or combinations thereof. For example, the user profile may be matched against a service personnel profile to determine when to transfer the digital representation of the user form the virtual waiting room into a virtual private room.

As mentioned above, the method (300) includes determining (303) a location of the wearable computing device. As mentioned above, determining the location of the wearable computing device includes utilizing GPS. In example, the wearable computing device is enabled with GPS. In an example, GPS is a spaced based satellite navigation system that provides location and time information anywhere on or near the earth where there is an unobstructed line of sight to four or more GPS satellites. In an example, the location and time the GPS provides may be utilized by the method (300) to determine a location of the wearable computing device according to common methods and techniques provided by GPS.

In another example, determining (303) a location of the wearable computing device includes determining proximity of the product to the wearable computing device. As mentioned above, the wearable computing device and a product may include one or more sensors that allows the method (300) to determine proximity of the wearable computing device to the product (210). In an example, the sensors may be wireless. In an example, a company may have two products, product A and product B. Further, a company may have one wearable computing device. In this example, the wearable computing device and the product may include one or more sensors. As mentioned above, the sensors determine a distance from the products to the wearable computing device.

In yet another example, determining (303) a location of the wearable computing device includes determining a history associated with the user profile. In one example, once the user is identified via the method (300), the method (300) may access the user profile, stored in the database to determine the location of the wearable computing device. For example, the user profile may include information that indicates the user works for company X which is located at address Y. In this example, the method (300) determines the wearable computing device is at location Y.

As mentioned above, the method (300) includes determining (304), based on the user profile and the location of the wearable computing device, a virtual waiting room to place the digital representation of the user in. In an example, the digital representation of the user is placed in the virtual waiting room until service personnel of the technical support center may assist the user. In an example, the technical support center may include thousands of virtual waiting rooms. The virtual waiting rooms may be tailored to specific user attributes and/or service personnel attributes such as specific service personnel, a country, a language, a skill level, other attributes, or combinations thereof. Depending on the user profile and location of the wearable computing device, the digital representation of the user may be placed in a specific virtual waiting room. As mentioned above, the virtual waiting room allows a user to present at least one question regarding the request and receive at least one solution to the at least one question regarding the request.

As mentioned above, the method (300) includes transferring (305), based on a match between the user profile and at least one personnel profile associated with the technical support center, the digital representation of the user from the virtual waiting room into a virtual private room.

In an example, transferring (305), based on a match between the user profile and at least one personnel profile associated with the technical support center, the digital representation of the user from the virtual waiting room into a virtual private room includes receiving user attributes associated with the user profile. As mentioned above, the user attributes may include preferred service personnel, a country, a language, a skill level, an installed base model for a product, other user attributes, or combinations thereof.

Further, transferring (305), based on a match between the user profile and at least one personnel profile associated with the technical support center, the digital representation of the user from the virtual waiting room into a virtual private room includes receiving service personnel attributes associated with service personnel profiles for all digital representations of service personnel in the virtual waiting rooms. As mentioned above, each of the digital representations of service personnel may have a specific service personnel profile. Further, each of the specific service personnel profiles may include service personnel attributes. In an example, the service personnel attributes may include, a country, a language, a skill level, an installed base model for a product, other user attributes, or combinations thereof.

Transferring (305), based on a match between the user profile and at least one personnel profile associated with the technical support center, the digital representation of the user from the virtual waiting room into a virtual private room further includes determining if the match is detected. For example, the method (300) compares specific user attributes with specific service personnel attributes for all digital representations of service personnel in the virtual waiting rooms. As mentioned above, this comparison may be made via a matrix. As mentioned above, for a match to be detected, user attributes such as country, language, skill level, and installed base model for a product are to match service personnel attributes such as country, language, skill level, and installed base model for a product.

Further, the method (300) assigns a priority to the match. In an example, each of the service personnel may be a match for user attributes to a degree. In an example, the priority may be symbolic such as high, medium, and low where low indicates that none of the user attributes match the service personnel attributes and high indicates that all of the user attributes match the service personnel attributes. In another example, the priority may be a scale, such as 0 to 10 where 0 indicates that none of the user attributes match the service personnel attributes and 10 indicates that all of the user attributes match the service personnel attributes.

The method (300) further allows, based on the priority of the match, the digital representation of the user to be transferred from the virtual waiting room into the virtual private room. In an example, common methods and techniques may be used to transfer the digital representation of the user from the virtual waiting room into the virtual private room. In an example, the service personnel attributes of service personnel that best match the user attributes allow the digital representation the user to be transferred to a virtual private room associated with the service personnel. In an example, if the priority of the match is low, the digital representation the user may not be transferred to a virtual private room associated with the service personnel.

In an example, transferring (305), based on the match between the user profile and the at least one service personnel profile associated with the technical support center, the digital representation of the user from the virtual waiting room into the virtual private room enables sharing of content related to the request between service personnel of the technical support center and the user via the wearable computing device associated with the user and computing devices associated with the service personnel. As mentioned above, the computing device for the service personnel may include features such as a microphone, audio speakers, a display, a camera, other features, or combinations thereof to send and receive content. As mentioned above, the wearable computing device may also send and receive content via features.

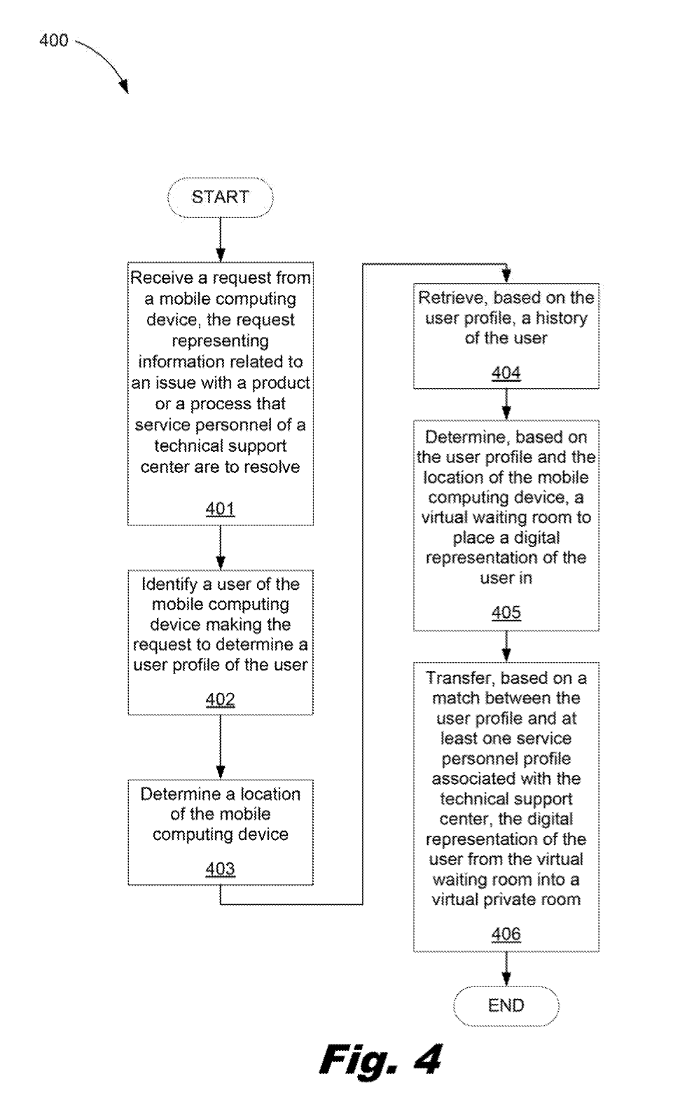

FIG. 4 is a flowchart of an example of a method for providing technical support to a user via a wearable computing device, according to one example of principles described herein. In one example, the method (400) may be executed by the system (100) of FIG. 1. In other examples, the method (400) may be executed by other systems such as system 200, system 500 or system 600. As a result, the functionalities of the method (400) are implemented by hardware or a combination of hardware and executable instructions. In this example, the method (400) includes receiving (401) a request from a wearable computing device, the request representing information related to an issue with a product or a process that service personnel of a technical support center are to resolve, identifying (402) a user of the wearable computing device making the request to determine a user profile of the user, determining (403) a location of the wearable computing device, retrieving (404), based on the user profile, a history of the user, determining (405), based on the user profile and the location of the wearable computing device, a virtual waiting room to place a digital representation of the user in, and transferring (406), based on a match between the user profile and at least one service personnel profile associated with the technical support center, the digital representation of the user from the virtual waiting room into a virtual private room.

As mentioned above, the method (400) includes retrieving (404), based on the user profile, a history of the user. The history may aid the providing system in determining a location of the wearable computing device, determining a virtual waiting room to place the digital representation of the user in, or combinations thereof. In an example, the history may include product records, texts, chats, documents, recordings, references, among others. Further, the history may be used to prepopulate a private waiting room so that continuity of technical support may be seamless and a premium user experience is provided.

FIG. 5 is a diagram of an example of a system for providing technical support to a user via a wearable computing device, according to one example of principles described herein. The providing system (500) includes a receive engine (502), an identify engine (504), a location engine (506), a virtual waiting room engine (508), and a transfer engine (510). In this example, the providing system (500) also includes a retrieve engine (512). The engines (502, 504, 506, 508, 510, 512) refer to a combination of hardware and program instructions to perform a designated function. Each of the engines (502, 504, 506, 508, 510, 512) may include a processor and memory. The program instructions are stored in the memory and cause the processor to execute the designated function of the engine. As a result, the functionalities of the providing system (500) are implemented by hardware or a combination of hardware and executable instructions.

The receive engine (502) receives a request from a wearable computing device, the request representing information related to an issue with a product or a process that service personnel of a technical support center are to resolve. In an example, the receive engine (502) receives at least one request from the wearable computing device.

The identify engine (504) identifies a user of the wearable computing device making the request to determine a user profile of the user. In one example, the identify engine (504) identifies the user of the wearable computing device making the request to determine the user profile of the user by identifying the user via biometrics, a QR code, a password, a user name, a company that has registered with the wearable computing device with the technical support center, a proximity of the wearable computing device to the product, or combinations thereof.

The location engine (506) determines a location of the wearable computing device. In one example, the location engine (506) determines the location of the wearable computing device by utilizing a GPS to determine the location of the wearable computing device, determining a proximity of the product to the wearable computing device to determine the location of the wearable computing device, determining a history associated with the user profile to determine the location of the wearable computing device, or combinations thereof.

The virtual waiting room engine (508) determines, based on the user profile and the location of the wearable computing device, a virtual waiting room to place a digital representation of the user in. In an example, the virtual waiting room allows a user to present at least one question regarding the request and receive at least one solution to the at least one question regarding the request.

The transfer engine (510) transfers, based on a match between the user profile and at least one personnel profile associated with the technical support center, the digital representation of the user from the virtual waiting room into a virtual private room. In one example, the transfer engine (510) transfers, based on a match between the user profile and at least one personnel profile associated with the technical support center, the digital representation of the user from the virtual waiting room into a virtual private room by receiving user attributes associated with the user profile, receiving service personnel attributes associated with the at least one service personnel profile, comparing the user attributes with the service personnel attributes to determine if the match is detected, assigning a priority to the match, and allowing, based on the priority of the match, the digital representation of the user to be transferred from the virtual waiting room into the virtual private room. In one example, the transfer engine (510) enables service personnel of the technical support center and the user via the wearable computing device.

The retrieve engine (512) retrieves, based on the user profile, a history of the user. In an example, the history may include product records, texts, chats, documents, recordings, references, among others. Further, the history may be used to prepopulate a private waiting room so that continuity of technical support may be seamless and a premium user experience is provided.

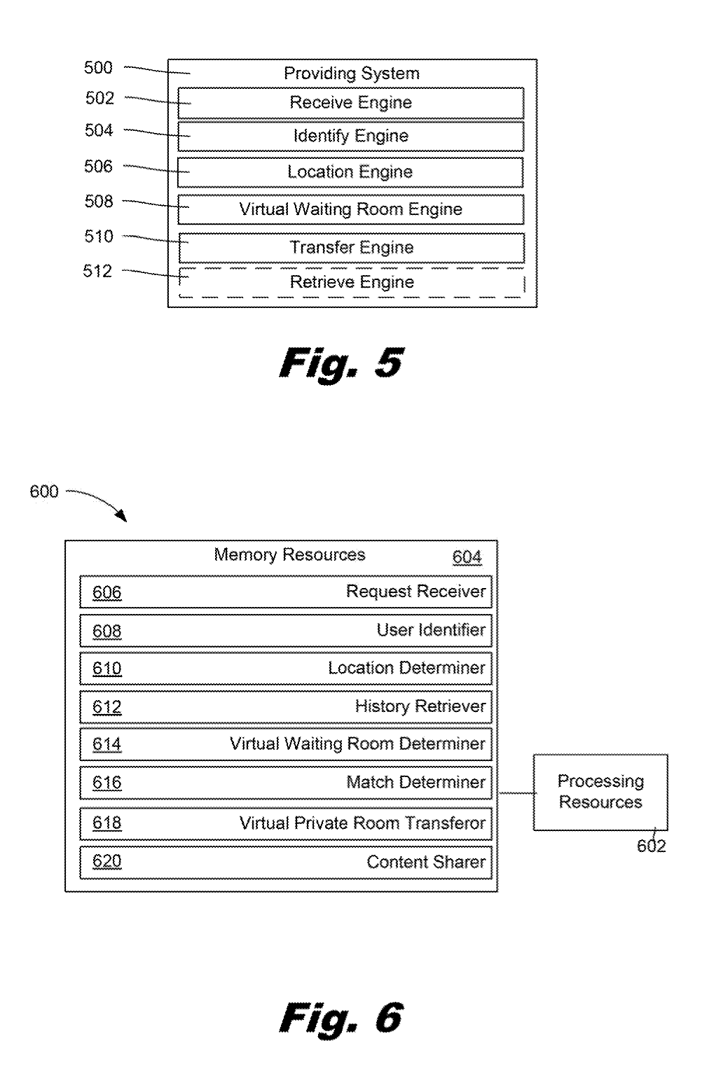

FIG. 6 is a diagram of an example of a system for providing technical support to a user via a wearable computing device, according to one example of principles described herein. In this example, providing system (600) includes processing resources (602) that are in communication with memory resources (604). Processing resources (602) include at least one processor and other resources used to process programmed instructions. The memory resources (604) represent generally any memory capable of storing data such as programmed instructions or data structures used by the providing system (600). The programmed instructions shown stored in the memory resources (604) include a request receiver (606), a user identifier (608), a location determiner (610), a history retriever (612), a virtual waiting room determiner (614), a match determiner (616), a virtual private room transferor (618), and a content sharer (620).

The memory resources (604) include a computer readable storage medium that contains computer readable program code to cause tasks to be executed by the processing resources (602). The computer readable storage medium may be tangible and/or physical storage medium. The computer readable storage medium may be any appropriate storage medium that is not a transmission storage medium. A non-exhaustive list of computer readable storage medium types includes non-volatile memory, volatile memory, random access memory, write only memory, flash memory, electrically erasable program read only memory, or types of memory, or combinations thereof.

The request receiver (606) represents programmed instructions that, when executed, cause the processing resources (602) to receive a request from a wearable computing device, the request representing information related to an issue with a product or a process that service personnel of a technical support center are to resolve. The user identifier (608) represents programmed instructions that, when executed, cause the processing resources (602) to identify a user of the wearable computing device making the request to determine a user profile of the user

The location determiner (610) represents programmed instructions that, when executed, cause the processing resources (602) to determine a location of the wearable computing device. The history retriever (612) represents programmed instructions that, when executed, cause the processing resources (602) to retrieve, based on the user profile, a history of the user.

The virtual waiting room determiner (614) represents programmed instructions that, when executed, cause the processing resources (602) to determine, based on the user profile and the location of the wearable computing device, a virtual waiting room to place a digital representation of the user in. The match determiner (616) represents programmed instructions that, when executed, cause the processing resources (602) to determine a match, based on a matrix, between the user profile and a service personnel profile.

The virtual private room transferor (618) represents programmed instructions that, when executed, cause the processing resources (602) to transfer, based on a match between the user profile and at least one personnel profile associated with the technical support center, the digital representation of the user from the virtual waiting room into a virtual private room. The content sharer (620) represents programmed instructions that, when executed, cause the processing resources (602) to share content related to the request between service personnel of the technical support center and the user via the wearable computing device and a service personnel device.

Further, the memory resources (604) may be part of an installation package. In response to installing the installation package, the programmed instructions of the memory resources (604) may be downloaded from the installation package's source, such as a portable medium, a server, a remote network location, another location, or combinations thereof. Portable memory media that are compatible with the principles described herein include DVDs, CDs, flash memory, portable disks, magnetic disks, optical disks, other forms of portable memory, or combinations thereof. In other examples, the program instructions are already installed. Here, the memory resources can include integrated memory such as a hard drive, a solid state hard drive, or the like.

In some examples, the processing resources (602) and the memory resources (602) are located within the same physical component, such as a server, or a network component. The memory resources (604) may be part of the physical component's main memory, caches, registers, non-volatile memory, or elsewhere in the physical component's memory hierarchy. Alternatively, the memory resources (604) may be in communication with the processing resources (602) over a network. Further, the data structures, such as the libraries, may be accessed from a remote location over a network connection while the programmed instructions are located locally. Thus, the providing system (600) may be implemented on a user device, on a server, on a collection of servers, or combinations thereof.

The providing system (600) of FIG. 6 may be part of a general purpose computer. However, in alternative examples, the providing system (600) is part of an application specific integrated circuit.

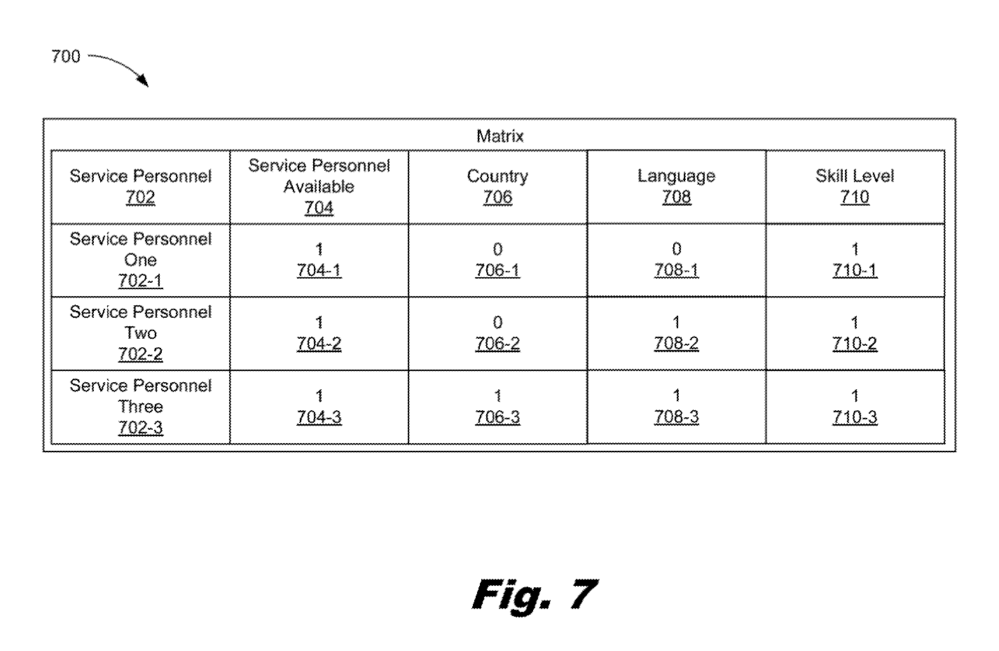

FIG. 7 is a diagram of an example of a matrix for comparing user attributes with service personnel attributes for a number of service personnel, according to one example of principles described herein. As mentioned above, the providing system compares user attributes with service personnel attributes to determine if a match is detected. Further, the providing system may use a matrix to compare the user attributes with the service personnel attributes. For example, the providing system may compare specific user attributes with specific service personnel attributes for all digital representations of service personnel in the virtual waiting rooms via a matrix.

As illustrated in FIG. 7, a matrix (700) may include a number of columns (702, 704, 706, 708, 710). In an example, the column columns (702, 704, 706, 708, 710) may correspond to service personnel (702), if the service personnel is available (704), and user attributes such as country (706), language (708), and skill level (710). In this example, all the service personnel are available as indicated by the l's in the service personnel available (704) column.

Further, the matrix (700) may include one or more rows. In an example, each row corresponds to a service personnel profile. As illustrated, the matrix includes service personnel one (702-1), service personnel two (702-2), and service personnel three (702-3). As mentioned above, if user attributes matches specific service personnel attribute in the matrix (700), an entry for the corresponding matrix (700) receives a 1, otherwise the entry for the corresponding matrix (700) may receive a 0. The more 1's on the row of the matrix (700), the more a service personnel profile matches a user profile.

In an example, for a match to be detected, user attributes such as country, language, skill level are to match service personnel attributes for country, language, skill level. For example, if the user attributes indicate that the user lives in German, speaks German, and has a novice skill level, these user attributes are compared against all service personnel attributes for all digital representations of service personnel in the virtual waiting rooms. For example, three digital representations of service personnel may be in the virtual waiting rooms. In one example, service personnel one's service personnel attributes indicate that service personnel one (702-1) lives in Spain, speaks Spanish, and has a novice skill level. In this example, the providing system determines service personnel one (702-1) matches one attribute of the user attributes. As illustrated, the matrix (700) receives one l's for the row corresponding to service personnel one (702-1). Further, service personnel two's service personnel attributes indicate that service personnel two (702-2) lives in France, speaks German and French, and has a novice skill level. In this example, the providing system determines service personnel two (702-2) matches two attributes of the user attributes. As illustrated, the matrix (700) receives two 1's for the row corresponding to service personnel two (702-2). Further, service personnel three's service personnel attributes indicate that service personnel three (702-3) lives in German, speaks German, and has a novice skill level. In this example, the providing system determines service personnel three (702-3) matches three attributes of the user attributes. As illustrated, the matrix (700) receives three 1's for the row corresponding to service personnel three (702-3). As mentioned above, the more 1's on the row of the matrix (700), the more a service personnel profile matches a user profile. As a result, the service personnel profile of service personnel three (702-3) may best match the user profile.

While this example has been described with reference to the matrix including a country attribute, a language attribute, a skill attribute, other user attributes may be included in the matrix. For example, the matrix may also include preferred service personnel, an installed base, other user attributes, or combinations thereof.

The preceding description has been presented to illustrate and describe examples of the principles described. This description is not intended to be exhaustive or to limit these principles to any precise form disclosed. Many modifications and variations are possible in light of the above teaching.

What is claimed is:

1. A method for providing technical support to a user via a wearable computing device, the method comprising:
receiving a request from a wearable computing device, the request representing information related to an issue with a product or a process that service personnel of a technical support center are to resolve;
identifying a user of the wearable computing device making the request to determine a user profile of the user;
determining a location of the wearable computing device;
determining, based on the user profile and the location of the wearable computing device, a virtual waiting room to place a digital representation of the user in; and
transferring, based on a match between the user profile and at least one service personnel profile associated with the technical support center, the digital representation of the user from the virtual waiting room into a virtual private room.

2. The method of claim 1, in which transferring, based on the match between the user profile and the at least one service personnel profile associated with the technical support center, the digital representation of the user from the virtual waiting room into the virtual private room comprises:
receiving user attributes associated with the user profile;
receiving service personnel attributes associated with the at least one service personnel profile; and
comparing the user attributes with the service personnel attributes to determine if the match is detected.

3. The method of claim 2, in which transferring, based on the match between the user profile and the at least one service personnel profile associated with the technical support center, the digital representation of the user from the virtual waiting room into the virtual private room further comprises:
assigning a priority to the match; and
allowing, based on the priority of the match, the digital representation of the user to be transferred from the virtual waiting room into the virtual private room.

4. The method of claim 1, in which the virtual waiting room allows the user to present at least one question regarding the request and receive at least one solution to the at least one question regarding the request.

5. The method of claim 1, in which transferring, based on the match between the user profile and the at least one service personnel profile associated with the technical support center, the digital representation of the user from the virtual waiting room into the virtual private room enables sharing of content related to the request between service personnel of the technical support center and the user via the wearable computing device in the virtual private room.

6. The method of claim 1, further comprising retrieving, based on the user profile, a history of the user.

7. A system for providing technical support to a user via a wearable computing device, the system comprising:
a receive engine to receive a request from a wearable computing device, the request representing information related to an issue with a product or a process;
an identify engine to identify a user of the wearable computing device making the request to determine a user profile of the user;
a location engine to determine a location of the wearable computing device;
a retrieve engine to retrieve, based on the user profile, a history of the user;
a virtual waiting room engine to determine, based on the user profile and the location of the wearable computing device, a virtual waiting room to place a digital representation of the user in; and
a transfer engine to transfer, based on a match between the user profile and at least one service personnel profile associated with the technical support center, the digital representation of the user from the virtual waiting room into a virtual private room;
in which the request comprising the information to determine a priority of the request.

8. The system of claim 7, in which the transfer engine transfers, based on the match between the user profile and the at least one service personnel profile associated with the technical support center, the digital representation of the user from the virtual waiting room into the virtual private room by:
receiving user attributes associated with the user profile;
receiving service personnel attributes associated with the at least one service personnel profile; and
comparing the user attributes with the service personnel attributes to determine if the match is detected.

9. The system of claim 8, in which the transfer engine transfers, based on the match between the user profile and the at least one service personnel profile associated with the technical support center, the digital representation of the user from the virtual waiting room into the virtual private room further by:
assigning a priority to the match; and
allowing, based on the priority of the match, the digital representation of the user to be transferred from the virtual waiting room into the virtual private room.

10. The system of claim 7, in which the virtual waiting room engine allows the user to present at least one question regarding the request and receive at least one solution to the at least one question regarding the request.

11. The system of claim 7, in which the transfer engine enables sharing of content related to the request between service personnel of the technical support center and the user via the wearable computing device in the virtual private room.

12. A computer program product for providing technical support to a user via a wearable computing device, comprising:
a tangible computer readable storage medium, said tangible computer readable storage medium comprising computer readable program code embodied therewith, said computer readable program code comprising program instructions that, when executed, causes a processor to:
identify a user of a wearable computing device making a request to determine a user profile of the user;
determine a location of the wearable computing device;
determine, based on the user profile and the location of the wearable computing device, a virtual waiting room to place a digital representation of the user in; and
transfer, based on a match between the user profile and at least one service personnel profile associated with a technical support center, the digital representation of the user from the virtual waiting room into a virtual private room.

13. The product of claim 12, further comprising computer readable program code comprising program instructions that, when executed, cause said processor to receive the request from the wearable computing device, the request representing information related to an issue with a product or a process that service personnel of the technical support center are to resolve.

14. The product of claim 12, further comprising computer readable program code comprising program instructions that, when executed, cause said processor to retrieve based on the user profile, a history of the user.

15. The product of claim 12, further comprising computer readable program code comprising program instructions that, when executed, cause said processor to:
receive user attributes associated with the user profile;
receive service personnel attributes associated with the at least one service personnel profile;
compare the user attributes with the service personnel attributes to determine if the match is detected;
assigning a priority to the match; and
allowing, based on the priority of the match, the digital representation of the user to be transferred from the virtual waiting room into the virtual private room.
